(19) United States
(12) Patent Application Publication
(10) Pub. No.: US 2021/0323720 A1
(43) Pub. Date: Oct. 21, 2021

(54) STRETCH WRAP HAND DISPENSER PRODUCED FROM NON-TRADITIONAL POLYMERS OR NATURAL MATERIALS

(71) Applicants: Steve Kohn, Short Hills, NJ (US); Amy Rigazio, Farmingdale, NY (US); Jaime Radakovich, Roselle Park, NJ (US)

(72) Inventors: Steve Kohn, Short Hills, NJ (US); Amy Rigazio, Farmingdale, NY (US); Jaime Radakovich, Roselle Park, NJ (US)

(21) Appl. No.: 17/359,577

(22) Filed: Jun. 27, 2021

Related U.S. Application Data
(62) Division of application No. 16/439,641, filed on Jun. 12, 2019.

(51) Int. Cl. B65D 5/46; B65B 25/14; B65H 35/00; C08L 97/02; C08J 5/04; B65D 85/672; B65H 16/00

(52) U.S. Cl. CPC B65D 5/46072; B65B 25/146; B65H 35/002; C08L 97/02; C08J 5/045; B65B 67/085; B65H 16/005; B65H 2701/1752; B65D 2571/00456; B65H 2402/412; B65D 85/672

(57) ABSTRACT

A handle produced from non-traditional polymers or natural materials used for dispensing stretch film. The handle provides the same functionality as current options but reduces the amount of single use plastic waste associated with stretch film usage.

### CROSS REFERENCE TO RELATED APPLICATIONS

This application claims benefit to and priority of divisional U.S. application Ser. No. 16/439,641 filed Jun. 12, 2019.

### FIELD OF THE INVENTION

The present invention relates to stretch wrap hand dispensers produced from non-traditional polymers or natural materials.

### BACKGROUND OF THE INVENTION

U.S. Pat. No. 10,077,137 relates to a combination carrying device that includes a rigid basket having a flexible nest therein. The flexible bag may be formed from one or more fabrics or like materials and form or define a tapered volume having a pair of handle extensions.

US patent publication 2011/0219631 relates to plastic cutlery and tableware made in at least two parts joinable to form a unitary utensil, serving piece, beverage container or non-food contacting tableware in which the two parts are made of different materials. The materials of the two parts differ in at least one of the following: color, type of plastic, grade of plastic, source of plastic, and additives such as the presence of an anti-microbial agent, transparency or reflectivity. Food-grade resins, for example, can be used for the heads of the cutlery while recycled resins can be used for the handles. Heads can be separately metallized and then joined to non-metallized handles.

US patent publications 2012/0046411 and 2015/0218354 relate to compositions including recycled resin components and medical devices and components made from such compositions. The compositions and medical devices are characterized as biocompatible and sterilization stable. The compositions include a recycled resin component and may include one or more of an anti-oxidant component, slip additive component, and anti-static component.

US patent publication 2009/0126204 relates to a product formed from a crop-based resin that decomposes into a compost within 120 days or less and is heat resistant being able to remain in hot water at a temperature of at least 190 degrees Fahrenheit for at least 15 minutes without any substantial loss in rigidity.

Handles that are used to dispense stretch film from a roll are historically produced using virgin polymers such as polyvinyl chloride or polypropylene. This is true for handles that are inserted into a roll's inner core, for handles that are slid over a roll's inner core, and for handles that are used in coreless applications. With consumers looking to produce less plastic waste and requesting more sustainable options, the present invention changes the basic material from which these handles are produced. The result is a fully functional handle that reduces the consumption of new petroleum based raw materials.

### SUMMARY OF THE INVENTION

The present invention relates to a handle produced from non-traditional polymers or natural materials used with stretch wrap hand dispensers. The handles are a separate device that is used with a film dispenser. The film dispensers comprise a core having film wrapped around it. The handles are either inserted inside the core of the film dispenser, or the film dispenser has an extended core wherein the extended core is inserted in the handle. It is an object of the present invention for the core or extended core to have a different coefficient of friction than that of the handle. The reason for this is so that the handle can be used as a braking mechanism, so that when squeezed the inner part of the handle touches the core, causing friction which then functions as a braking mechanism to stop the film dispenser from dispensing film. It is an object of the present invention for the inside of the handle to comprise ribs or other projections extending from the inner surface of the handle. It is an object of the present invention for the walls of the handle to be deformable so that they can be squeezed by pressure from a human hand, and when the pressure is released the walls are back in their normal place.

The present invention relates to a handle that is a cylinder with side walls having a closed bottom. It is an object of the present invention for the top of the cylinder to have a plug or extension that fits within a core of a film dispenser in a way that the handle is held within the film dispenser, but can be removed with some degree of force.

It is an object of the present invention for the handle to comprise a cylinder with an opening at the top of the cylinder, side walls and a closed bottom. It is an object of the present invention for the handle to have a collar extending from the top opening.

The present invention directly replaces existing stretch wrap handles produced from traditional resins with handles produced from more sustainable materials. It is an object of the present invention for these sustainable options to include recycled resins, bioplastics, natural rubbers, and fiber-based composites.

It is an object of the present invention for the handles to be produced from recycled resin. It is an object of the present invention for the handles produced from recycled resin to contain 100% post-consumer recycled content. It is an object of the present invention for the handles produced from recycled resin to contain a blend of post-consumer recycled content and virgin resin. It is an object of the present invention for the handles produced from recycled resin to contain 100% post-industrial recycled content. It is an object of the present invention for the handles produced from recycled resin to contain a blend of post-industrial recycled content and virgin resin. It is an object of the present invention for the handles produced from recycled resin to contain 100% recycled content as a blend of post-industrial and post-consumer recycled content. It is an object of the present invention for the handles produced from recycled resin to contain a blend of post-industrial recycled content, post-consumer recycled content, and virgin resin.

The present invention relates to attaching a handle produced from recycled resin to a stretch wrap dispenser. It is an object of the present invention to slide a handle produced from recycled resin over an extended core of a stretch wrap dispenser. It is an object of the present invention for the extended core to have a groove in it so that the handle produced from recycled resin can removably attach to the extended core. It is an object of the present invention to slide a handle produced from recycled resin over the extended core of a stretch wrap dispenser where the core does not have a groove. It is an object of the present invention to insert a handle produced from recycled resin into the end of the core of a stretch wrap dispenser. It is an object of the present invention for a handle produced from recycled resin to be used in coreless applications on stretch wrap dispensers.

It is an object of the present invention for the handles produced from recycled resin to be of a single-piece construction. It is an object of the present invention for the handles produced from recycled resin to be comprised of multiple pieces, such as side wall, bottom piece and internal pieces.

It is an object of the present invention for the handles produced from recycled resin to be used in single handle applications for rolls of stretch film from 2″ to 15″ wide. It is an object of the present invention for the handles produced from recycled resin to be used as pairs in multiple handle applications for rolls of stretch film from 8″ to 30″ wide.

It is an object of the present invention for the handles produced from recycled resin to be recyclable.

It is an object of the present invention for the handles to be produced from bioplastics. It is an object of the present invention for the handles produced from bioplastics to contain 100% biobased polymers. It is an object of the present invention for the handles produced from bioplastics to contain a blend of natural starches and biobased polymers. It is an object of the present invention for the handles produced from bioplastics to contain a blend of natural starches and synthetic resins.

The present invention relates to attaching a handle produced from bioplastics to a stretch wrap dispenser. It is an object of the present invention to slide a handle produced from bioplastics over an extended core of a stretch wrap dispenser. It is an object of the present invention for the extended to have a groove in it to so that the handle can removably attach to the extended core. It is an object of the present invention to slide a handle produced from bioplastics over the extended core of a stretch wrap dispenser where the core does not have a groove. It is an object of the present invention to insert a handle produced from bioplastics into the end of the core of a stretch wrap dispenser. It is an object of the present invention for a handle produced from bioplastics to be used in coreless applications on stretch wrap dispenser.

It is an object of the present invention for the handles produced from bioplastics to be of a single-piece construction. It is an object of the present invention for the handles produced from bioplastics to be comprised of multiple pieces, such as side wall, bottom piece and internal pieces.

It is an object of the present invention for the handles produced from bioplastics to be used in single handle applications for rolls of stretch film from 2″ to 15″ wide. It is an object of the present invention for the handles produced from bioplastics to be used as pairs in multiple handle applications for rolls of stretch film from 8″ to 30″ wide.

It is an object of the present invention for the handles produced from bioplastics to be compostable. It is an object of the present invention for the handles produced from bioplastics to be recyclable. It is an object of the present invention for the handles produced from bioplastics to be biodegradable.

It is an object of the present invention for the handles to be produced from natural rubber. It is an object of the present invention for the handles produced from natural rubber to contain 100% organic compounds. It is an object of the present invention for the handles produced from natural rubber to contain a blend of organic and inorganic compounds. It is an object of the present invention for the handles produced from natural rubber to contain vulcanized rubber.

The present invention relates to attaching a handle produced from natural rubber to a stretch wrap dispenser. It is an object of the present invention to slide a handle produced from natural rubber over an extended core of a stretch wrap dispenser. It is an object of the present invention for the extended core to have a groove in it so that the handle can removably attach to the extended core. It is an object of the present invention to slide a handle produced from natural rubber over the extended core of a stretch wrap dispenser where the core does not have a groove. It is an object of the present invention to insert a handle produced from natural rubber into the end of the core of a stretch wrap dispenser. It is an object of the present invention for the handles produced from natural rubber to be used in coreless applications on stretch wrap dispensers.

It is an object of the present invention for the handles produced from natural rubber to be of a single-piece construction. It is an object of the present invention for the handles produced from natural rubber to be comprised of multiple pieces, such as side wall, bottom piece and internal pieces.

It is an object of the present invention for the handles produced from natural rubber to be used in single handle applications for rolls of stretch film from 2″ to 15″ wide. It is an object of the present invention for the handles produced from natural rubber to be used as pairs in multiple handle applications for rolls of stretch film from 8″ to 30″ wide.

It is an object of the present invention for the handles produced from natural rubber to be recyclable.

It is an object of the present invention for the handles to be produced from fiber-based composites. It is an object of the present invention for the handles produced from fiber-based composites to contain a blend of wood pulp and a binding agent. It is an object of the present invention for the handles produced from fiber-based composites to contain a blend of wood pulp and bioplastic. It is an object of the present invention for the handles produced from fiber-based composites to contain a blend of wood pulp and recycled resins. It is an object of the present invention for the handles produced from fiber-based composites to contain a blend of plant-based fibers and a binding agent. It is an object of the present invention for the handles produced from fiber-based composites to contain a blend of plant-based fibers and bioplastic. It is an object of the present invention for the handles produced from fiber-based composites to contain a blend of plant-based fibers and recycled resins.

The present invention relates to attaching a handle produced from fiber-based composites to a stretch wrap dispenser. It is an object of the present invention to slide a handle produced from fiber-based composites over an extended core of a stretch wrap dispenser. It is an object of the present invention for the extended core to have a groove in it so that the handle can removably attach to the extended core. It is an object of the present invention to slide a handle produced from fiber-based composites over the extended core of a stretch wrap dispenser where the core does not have a groove. It is an object of the present invention to insert a handle produced from fiber-based composites into the end of the core of a stretch wrap dispenser. It is an object of the present invention for a handle produced from fiber-based composites to be used in coreless applications on stretch wrap dispensers.

It is an object of the present invention for the handles produced from fiber-based composites to be of a single-piece construction. It is an object of the present invention for the handles produced from fiber-based composites to be comprised of multiple pieces, such as side wall, bottom piece and internal pieces.

It is an object of the present invention for the handles produced from fiber-based composites to be used in single handle applications for rolls of stretch film from 2″ to 15″ wide. It is an object of the present invention for the handles produced from fiber-based composites to be used as pairs in multiple handle applications for rolls of stretch film from 8″ to 30″ wide.

It is an object of the present invention for the handles produced from fiber-based composites to be compostable. It is an object of the present invention for the handles produced from fiber-based composites to be recyclable. It is an object of the present invention for the handles produced from fiber-based composites to be biodegradable.

It is an object of the present invention for the handle produced from non-traditional polymers or natural materials used with stretch wrap hand dispensers to be reusable. Once the film is dispensed from the film dispenser, the film dispenser is removed from the handle, and a further film dispenser is then used with the handle.

### BRIEF DESCRIPTION OF THE DRAWINGS

FIG. 1a shows a profile view of a handle of the present invention designed to slide over an extended core. FIG. 1b show a top view of the handle.

FIG. 2a shows the handle of FIG. 1 being placed over an extended core of a single handle application. FIG. 2b shows the extended core fully seated in the handle.

FIG. 3 shows an embodiment of the present invention showing two handles sliding over a stretch film roll's extended core in a multiple handle application.

FIG. 4 shows an embodiment of the present invention showing a top view of a handle designed to be inserted into a stretch film roll's inner core.

FIG. 5 shows an embodiment of the present invention showing a side view of a handle designed to be inserted into a stretch film roll's inner core.

FIG. 6 shows an embodiment of the present invention showing two handles, the type shown in

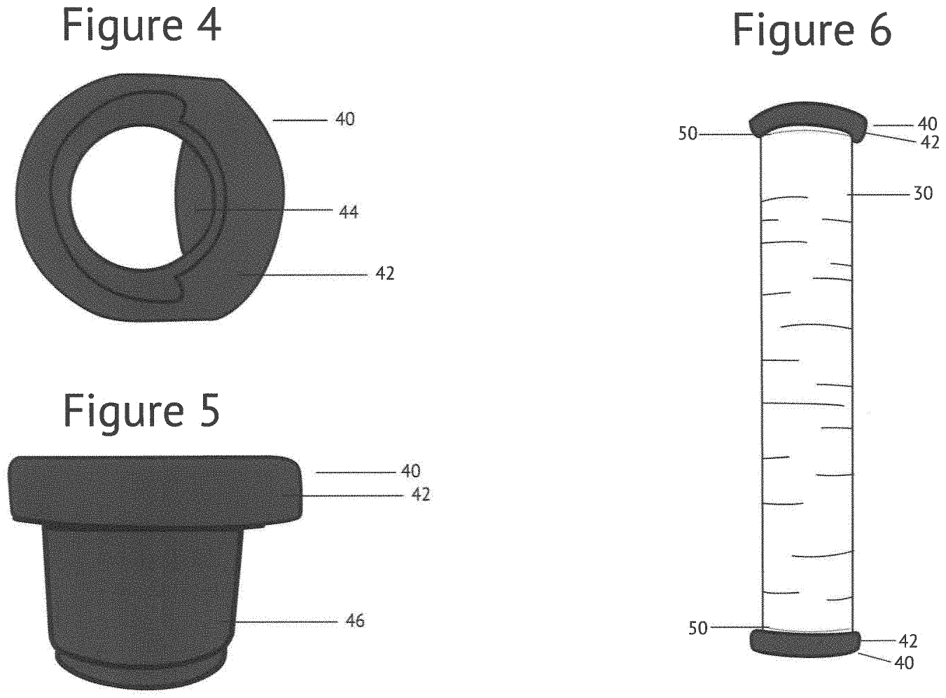

FIGS. 4 and 5, sliding into a stretch film roll's inner core in a multiple handle application.

FIG. 7 show an embodiment of the present invention showing components of a handle designed for a coreless application.

FIG. 8 shows an embodiment of the present invention showing the handle of FIG. 7 installed in a coreless application.

### DETAILED DESCRIPTION OF THE DRAWINGS

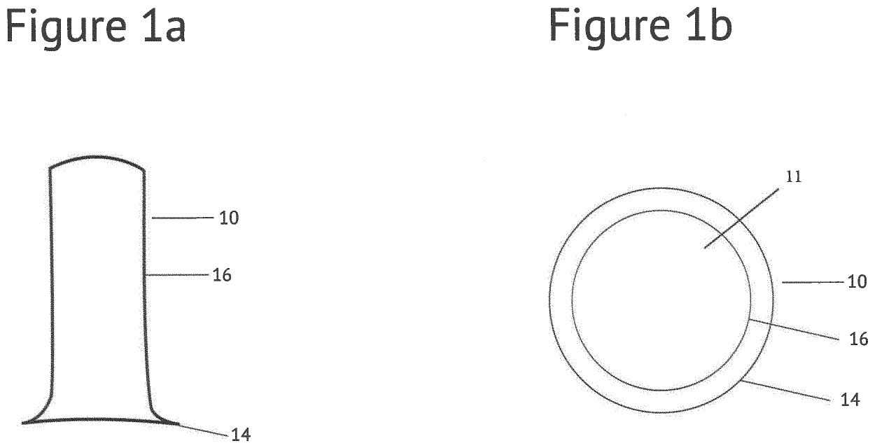

FIG. 1a shows a profile of a handle 10 having a collar 14 and a side wall in the form of a cylinder 16. FIG. 1b shows a top view of handle 10 showing the collar 14, the side walls 16 and the top opening 11.

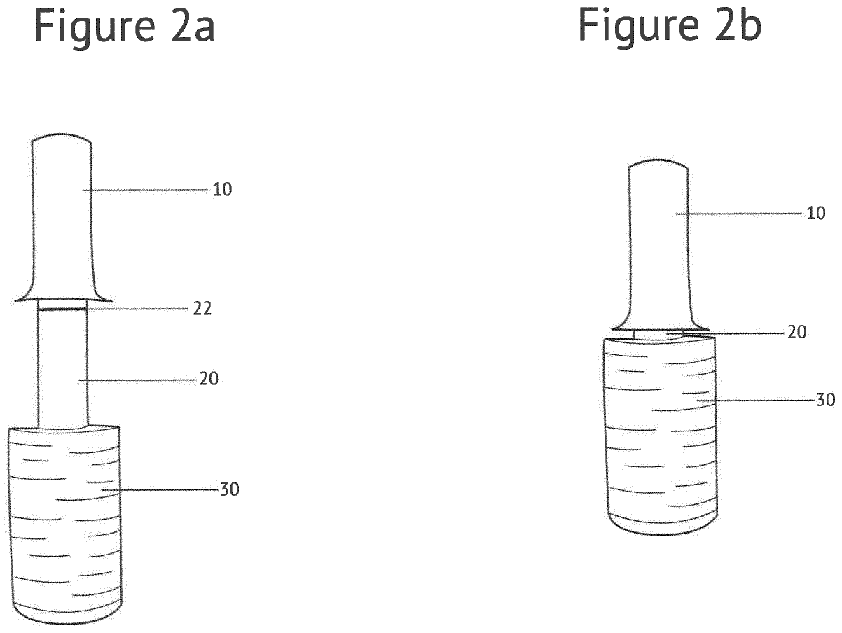

FIG. 2a shows handle 10 made from non-traditional polymers or natural materials in a single handle application. The extended core 20 extends past one edge of the stretch film 30. The extended core 20 has a grove 22 which will attach to a device on the inside of the handle 10. In FIG. 2b, the handle 10 slides over the extended core 20 and becomes fully seated before contacting film 30.

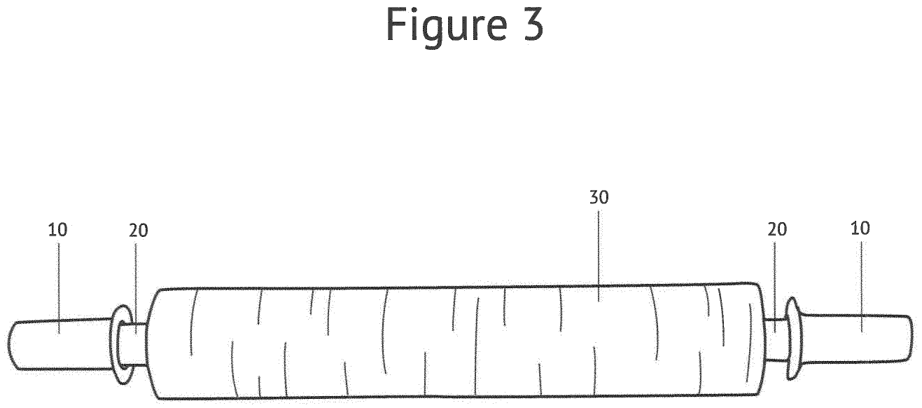

FIG. 3 shows handles 10 made from non-traditional polymers or natural materials in a multiple handle application. The extended core 20 extends past both edges of the stretch film 30. A handle 10 slides over the extended core 20 on one end of the roll, and second handle 10 slides over the extended core 20 on the opposite end.

FIG. 4 shows the top view of handle 40 made from non-traditional polymers or natural materials designed to be inserted into a stretch film roll's inner core. The handle shown has an outer surface 42 which the user holds when unrolling the film. There is an inner braking mechanism 44 that the user will squeeze to increase tension on the film as it is being unrolled.

FIG. 5 shows the side view of handle 40 made from non-traditional polymers or natural materials designed to be inserted into a stretch film roll's inner core. The insert 46 is sized to fit snuggly within the inner core while the outer surface 42 is wide and stays located outside of the core.

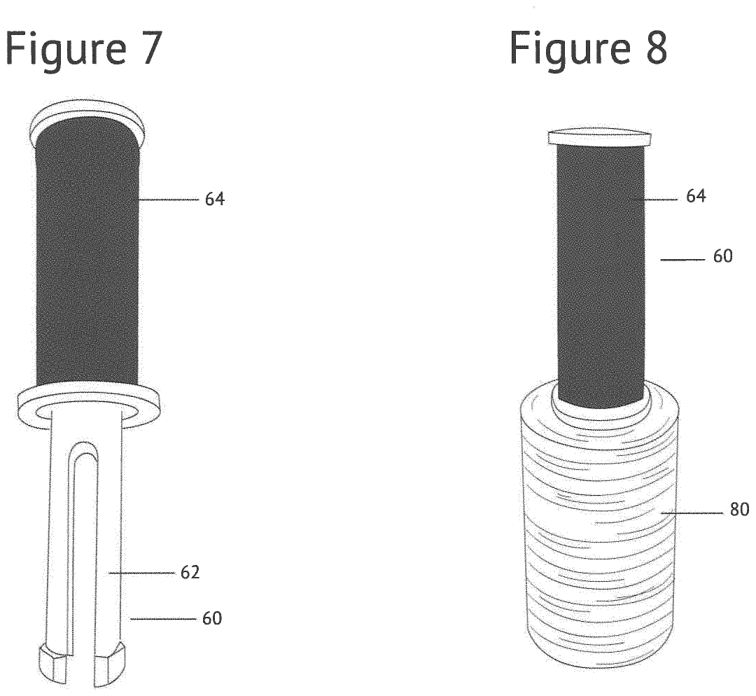

FIG. 6 shows handle 40 with an outer surface 42 made from non-traditional polymers or natural materials in a multiple handle application. The inner core 50 is approximately flush with both edges of the stretch film 30. The insert portion 46 (not shown) of handle 40 slides into core 50 on one end of the roll, and second handle 40 is installed into the opposite end in the same manner.

FIG. 7 shows a multi-piece handle 60 made from non-traditional polymers or natural materials designed for a coreless application. In place of a core, section 62 is inserted through the center of the roll of film leaving a graspable area 64 extended past the edge of the film.

FIG. 8 shows the multi-piece handle 60 made from non-traditional polymer or natural materials installed in a coreless application. Once inserted, section 62, shown in FIG. 7, is located within the coreless stretch film 80 and is not visible. The graspable area 64 extends past the edge of the coreless film 80.

1. A handle used with a stretch film dispenser to dispense stretch film from a roll comprising:
a cylinder with side walls having a closed bottom and an opening on top of said cylinder for holding said stretch film;
said handle consisting of recycled resins.

2. The handle of claim 1 further comprising:
said handle having a collar extending from the top opening.

3. The handle of claim 1 wherein said opening slides over an extended core of said stretch film dispenser.

4. The handle of claim 3 wherein said extended core has a groove to removably attach to said handle.

5. The handle of claim 3 wherein said handle and said extended core have different coefficients of friction and said handle is deformable.

6. The handle of claim 3 wherein ribs or other projections extend from inner surface of said handle.

7. The handle of claim 1 wherein said handle comprises a plug or extension that is inserted into a core of said stretch film dispenser.

8. The handle of claim 1 wherein said handle is used in place of a core of said stretch film dispenser.

9. The handle of claim 1 wherein said recycled resins are 100% post-consumer recycled content.

10. The handle of claim 1 wherein said recycled resins are a blend of post-consumer recycled content with virgin resin.

11. The handle of claim 1 wherein said recycled resins are 100% post-industrial recycled content.

12. The handle of claim 1 wherein said recycled resins are a blend of post-industrial recycled content with virgin resin.

13. The handle of claim 1 wherein said recycled resins contain 100% recycled content as a blend of post-consumer and post-industrial recycled content.

14. The handle of claim 1 wherein said recycled resins contain a blend of post-consumer and post-industrial recycled content with virgin resin.

15. The handle of claim 1 wherein said handle is made of single piece construction.

16. The handle of claim 1 wherein said handle is comprised of multiple pieces.

17. The handle of claim 1 wherein said handle is used in single handle applications for rolls of stretch film from about 2″ to 15″ wide.

18. The handle of claim 1 wherein said handle is a pair of handles used in a multiple handle application for rolls of stretch film from about 8″ to 30″ wide.

19. The handle of claim 1 wherein said handle is recyclable.
